(19) United States
(12) Patent Application Publication
(10) Pub. No.: US 2026/0141091 A1
(43) Pub. Date: May 21, 2026

(54) RECOMMENDATION AND REMEDIATION ROLE-BASED ACCESS CONTROL POSTURES FOR IDENTITIES

(71) Applicants: Subramanian Rama, Irving, TX (US); Suraj Ranganath, Bangalore (IN); Dalwinderjeet Grewal, Cedar Park, TX (US); Kush Ojha, Thane (IN); Anish Raghavendra, Bangalore (IN); Vishesh Bansal, Gurgaon (IN); Ankush Deep, Oakland, CA (US)

(72) Inventors: Subramanian Rama, Irving, TX (US); Suraj Ranganath, Bangalore (IN); Dalwinderjeet Grewal, Cedar Park, TX (US); Kush Ojha, Thane (IN); Anish Raghavendra, Bangalore (IN); Vishesh Bansal, Gurgaon (IN); Ankush Deep, Oakland, CA (US)

(21) Appl. No.: 19/450,372

(22) Filed: Jan. 15, 2026

Related U.S. Application Data
(63) Continuation-in-part of application No. 19/195,207, filed on Apr. 30, 2025, now abandoned.
(63) Continuation-in-part of application No. 19/194,684, filed on Apr. 30, 2025.
(63) Continuation-in-part of application No. 19/194,524, filed on Apr. 30, 2025.
Application No. 19/194,684 is a continuation-in-part of application No. 19/055,635, filed on Feb. 18, 2025.
(60) Provisional application No. 63/641,400, filed on May 1, 2024.
(60) Provisional application No. 63/641,397, filed on May 1, 2024.
(60) Provisional application No. 63/641,395, filed on May 1, 2024.
(60) Provisional application No. 63/641,391, filed on May 1, 2024.
(60) Provisional application No. 63/641,385, filed on May 1, 2024.
(60) Provisional application No. 63/641,383, filed on May 1, 2024.
(60) Provisional application No. 63/640,944, filed on May 1, 2024.
(60) Provisional application No. 63/640,932, filed on May 1, 2024.
(60) Provisional application No. 63/640,927, filed on May 1, 2024.
(60) Provisional application No. 63/640,926, filed on May 1, 2024.
(60) Provisional application No. 63/640,917, filed on May 1, 2024.
(60) Provisional application No. 63/642,929, filed on May 6, 2024.
(60) Provisional application No. 63/701,516, filed on Sep. 30, 2024.

(51) Int. Cl. G06F 21/60

(52) U.S. Cl. CPC G06F 21/604; G06F 2221/2137; G06F 2221/2141

(57) ABSTRACT

An automated, analytics-driven invention that generates, validates, and orchestrates unified RBAC postures spanning cloud infrastructure, SaaS applications, and on-premise assets. The method ingests entitlement data, HRIS attributes, behavioral data, and security policy constraints to identify common access patterns, detect anomalies, and recommend consolidated roles that embody the principle of least privilege. A dual-perspective algorithm—bottom-up clustering of shared connections and top-down evaluation of organizational context—produces high-fidelity roles annotated with confidence scores. The system surfaces actionable insights such as over-entitlement, under-entitlement, segregation-of-duties conflicts, and duplicate connections, then prescribes remediation playbooks or just-in-time enforcement. By continuously comparing the current state to a dynamically computed ideal state, the invention guides enterprises toward an access model that minimizes risk, streamlines audits, and reduces administrative drag.

### CROSS-REFERENCE TO RELATED APPLICATIONS

This application is a Continuation-in-Part Utility patent application claiming priority to U.S. patent application Ser. No. 19/195,207, filed on Apr. 30, 2025, which claims priority to U.S. patent application Ser. No. 19/055,635, filed on Feb. 18, 2025, which claims priority to U.S. Provisional Patent Application Ser. No. 63/641,397, filed on May 1, 2024, U.S. Provisional Patent Application Ser. No. 63/641,385, filed on May 1, 2024, U.S. Provisional Patent Application Ser. No. 63/640,944, filed on May 1, 2024, U.S. Provisional Patent Application Ser. No. 63/640,932, filed on May 1, 2024, U.S. Provisional Patent Application Ser. No. 63/640,927, filed on May 1, 2024, U.S. Provisional Patent Application Ser. No. 63/640,926, filed on May 1, 2024, to which are incorporated by reference herein in their entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to computer-implemented identity and access-management systems, and more particularly to automated generation and maintenance of Role-Based Access Control (RBAC) configurations across heterogeneous computing environments.

### 2) Description of Related Art

In computer systems security, role-based access control (RBAC) or role-based security is an approach to restricting system access to authorized users, and to implementing mandatory access control (MAC) or discretionary access control (DAC). Role-based access control is a policy-neutral access control mechanism defined around roles and privileges. The components of RBAC such as role-permissions, user-role and role-role relationships make it simple to perform user assignments. RBAC addresses many needs of commercial and government organizations and can be used to facilitate administration of security in large organizations with hundreds of users and thousands of permissions.

Conventional RBAC solutions assume a small set of stable business applications and roles that change infrequently. In contemporary enterprises, however, employees, contractors, service accounts, and automated pipelines interact with cloud platforms, SaaS services, and on-premises resources that are created and retired on a daily basis. Each system expresses privileges in its own vocabulary. Consequently, administrators must curate hundreds of disparate role catalogs and still cannot obtain an authoritative, up-to-date map of who can perform which sensitive actions.

Current governance tools exhibit three technical deficiencies including static role catalogs, role sprawl and duplication, siloed visibility, and manual remediation. Once defined, roles are seldom re-evaluated, allowing unused or excessive permissions to persist (“RBAC drift”). Slight variations in access requirements spawn overlapping or nearly identical roles, complicating audits and diluting least-privilege intent. Connectors operate per application and do not reason about privilege combinations that span multiple systems. Periodic access reviews and ticket-driven revocation processes are labor-intensive and prone to omission.

These shortcomings hinder enforcement of least-privilege principles and complicate compliance with security standards that require demonstrable, continuous control over entitlements. The disclosed method continuously ingests entitlement data from diverse sources, correlates it with organizational context and policy constraints, and algorithmically synthesizes high-confidence roles that reflect actual usage. The system detects over-entitlement, segregation-of-duties conflicts, and other anomalies in real time, then drives automated or workflow-based remediation. By replacing static, manual RBAC administration with data-driven, self-updating role generation, the invention maintains least-privilege access while reducing operational overhead.

Modern enterprises rely on an ever-expanding constellation of cloud services, SaaS platforms, on-premises systems, and automation scripts to conduct routine business operations. Each system introduces its own identities, roles, groups, and fine-grained permissions. As employees join, depart, or shift responsibilities, the mapping between people and privileges drifts. Identities proliferate (“identity sprawl”), and individual accounts quietly accumulate access well beyond the needs of their current functions (“over-entitlement”).

The cumulative effect is a swollen attack surface in which: Visibility is fragmented. Security teams cannot authoritatively answer the fundamental question, “Who can do what, where, and why?” across all environments.

Manual remediation does not scale. Access reviews, joiner/mover/leaver workflows, and compliance attestations consume thousands of staff-hours and still miss latent risks.

Least-privilege principles collapse. Excessive standing privileges increase the probability and blast radius of insider threats, credential-stuffing attacks, and accidental data exposure, while also violating regulatory frameworks such as PCI-DSS, HIPAA, and SOX.

A purely manual or application-specific approach to Role-Based Access Control (RBAC) therefore fails to deliver durable security or operational efficiency. A new, data-driven, organization-wide method is required—one that continuously mines entitlements, evaluates business context, and synthesizes precise roles that shrink privilege to what is strictly necessary while preserving productivity.

### BRIEF SUMMARY OF THE INVENTION

The instant invention in one form is directed to a method to discover and group permissions by analyzing the intersection of identities and the resources they actively consume, thereby eliminating redundant role definitions and connection duplication. The method integrates human resource information system data including department, job title, manager hierarchy, location, and tenure to calculate a statistical confidence score that quantifies role relevance within a peer group. The method enforces the principle of least privilege by applying tunable policy constraints (e.g., maximum privilege power versus resource sensitivity, SoD rules, behavioral usage thresholds), automatically flagging violations. The method generates role-merge and role-split recommendations based on overlap analysis and segregation-of-duties checks, ensuring that each synthesized role is internally consistent and non-redundant. An ideal role-resource graph is produced by simulating the remediation of every open finding; the system then measures and reports RBAC drift—the delta between the ideal and live graphs in real time, giving security teams a quantitative target for continuous improvement. The method exposes a risk-weighted findings engine that aggregates insight labels (outlier, over-entitled, below-threshold, unused access, duplicate connection) into holistic findings per identity, application, or business role, complete with impact explanations and remediation workflows. A machine-learning pipeline ingests organizational location, privilege envelope, and accessibility-graph features and assigns every resource a Very-Low to Very-High sensitivity tier, enabling precise risk evaluation of resources that are independent of manual tagging. The model incorporates an active-learning feedback loop whereby administrator edits to resource-sensitivity labels are stored as training data and used to retrain the classifier, yielding progressively higher accuracy without full retraining cycles. Tenant-configurable confidence thresholds allow each organization to fine-tune sensitivity and role confidence thresholds; deviations from these thresholds instantly spawn findings whose risk weights scale with the size of the deviation, ensuring that the most anomalous privileges rise to the top of remediation queues. The method operates in a zero-touch mode, requiring customers only to connect integrations; the system harvests entitlements, synthesizes RBAC, and presents prioritized recommendations without manual rule-writing unless preferred by the organization.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a flowchart of a method of control according to the present invention.

FIG. 2 shows a confidence score equation according to the present invention.

FIG. 3 shows a flowchart for a method of prediction.

FIG. 4 shows an organization chart according to the present invention.

FIG. 5 is a sensitivity model according to an aspect of the invention.

FIG. 6 shows a flowchart showing the process of building the model of FIG. 5.

FIG. 7 shows a mapping rule table.

FIG. 8 shows an assumption chart of the features.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The present disclosure relates to an automated Role-Based Access Control (RBAC) system for managing access rights across diverse computing environments. The system addresses challenges associated with identity sprawl, over-entitlement, and manual access management in modern enterprises. The automated RBAC system incorporates multiple components to achieve comprehensive access control. These components include data acquisition modules, role mining algorithms, contextualization processes, and remediation mechanisms. The system continuously ingest sand analyzes data from various sources to maintain an up-to-date understanding of access patterns and organizational structure.

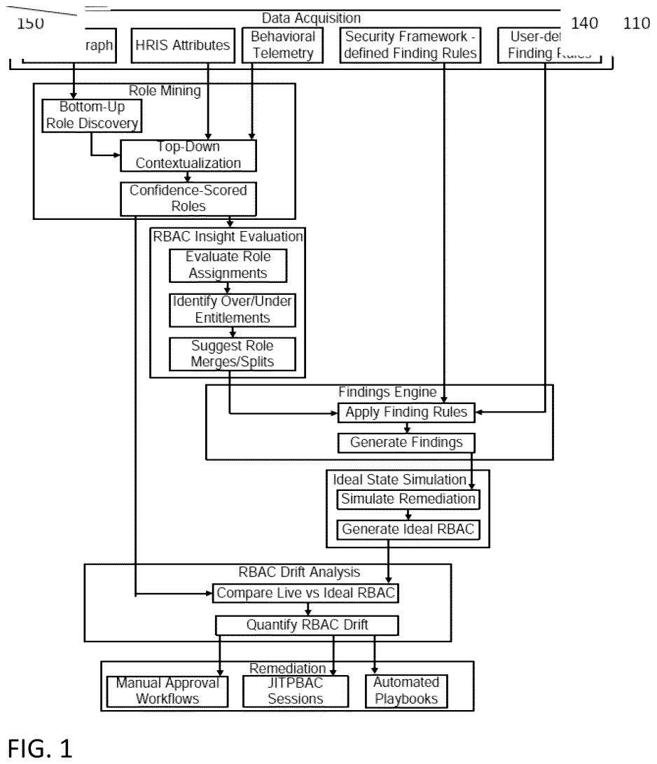

FIG. 1 illustrates a flowchart 100 of the automated RBAC system. The system begins with data acquisition 110 from multiple sources, including identity graphs, Human Resource Information System (HRIS) attributes, and behavioral telemetry. This data then feeds into role mining processes 120 which incorporate both bottom-up discovery and top-down contextualization approaches. The system employs advanced algorithms for RBAC insight evaluation 130, generate findings, and recommend remediation actions. The system compares live RBAC states against ideal states to identify and quantify drift, enabling continuous optimization of access control policies.

The acquired data may provide a comprehensive view of the organization's structure, user roles, and access patterns. The process may incorporate both bottom-up role discovery and top-down contextualization approaches. The bottom-up discovery may analyze connection patterns between users and resources, while the top-down contextualization may integrate organizational context derived from HRIS data. The role mining process may feed into an RBAC insight evaluation phase. During this phase, the system may evaluate role assignments, identify potential exceptions, and suggest role misalignments. This insight may be crucial for maintaining an effective and secure access control structure.

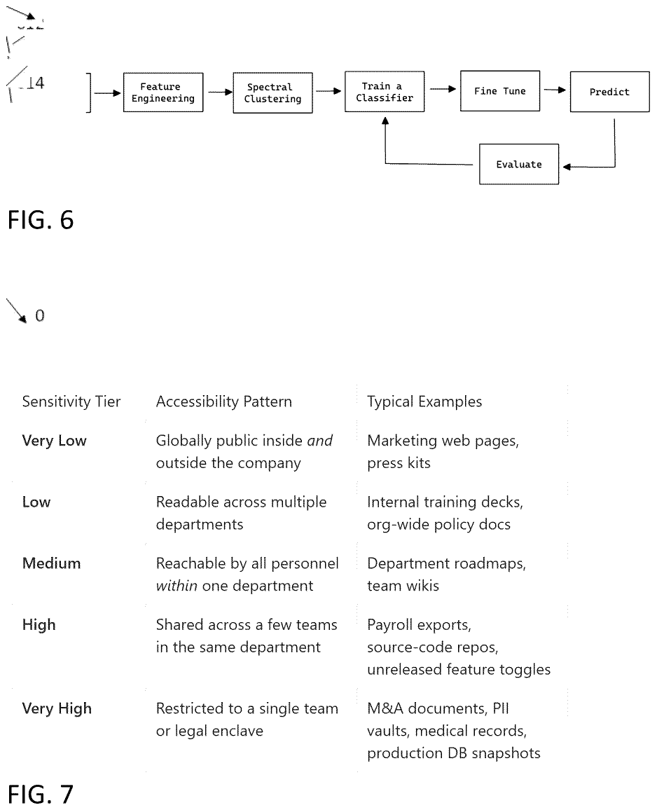

Based on the RBAC insights, a findings generation process may be initiated. This process may apply predefined firing rules to generate specific findings related to access control issues. The findings may highlight areas that require attention or remediation. The system may then proceed to a remediation phase 170. As illustrated in FIG. 1, this phase may include multiple pathways for addressing identified issues. These pathways may include manual approval workflows, Just-In-Time Purpose-Based Access Control (JITPBAC) sessions, and automated playbooks. The choice of remediation pathway may depend on the nature and severity of the identified issues. The system employs machine learning techniques to enhance its analysis and decision-making capabilities. FIG. 6 shows a flowchart 600 of a machine learning pipeline that may be integrated into the RBAC system. This pipeline provides feature engineering 604, spectral clustering 606, and classifier training steps 608, 610, 612, 614 to improve the system analyze and categorize access patterns for data 602. The training includes training a classifier 608, fine tuning 610, predicting 612, and evaluating 614 for continual improvement of the system.

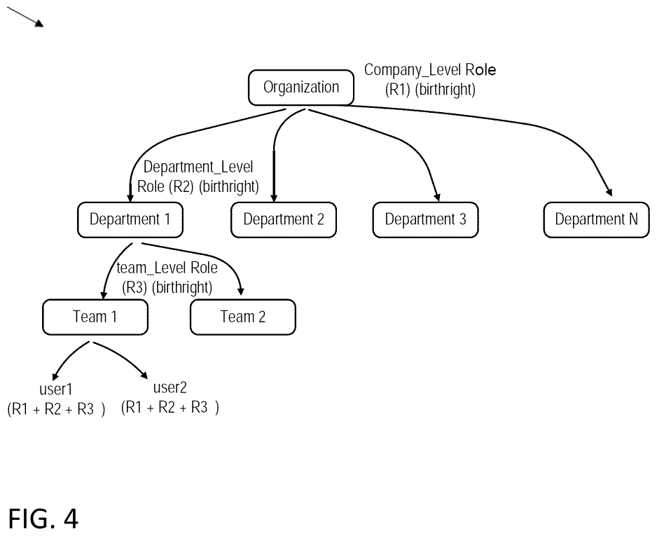

The RBAC system may support a hierarchical role structure that aligns with organizational levels. FIG. 4 illustrates an example of this hierarchy, which may include the company level role, the department level role, and the team level role. This structure may allow for granular access control while maintaining consistency across the organization. By continuously cycling through these processes, the automated RBAC system may maintain an up-to-date and optimized access control environment. The system may adapt to changes in organizational structure, user behavior, and security requirements, providing a dynamic solution for managing access rights in complex enterprise settings. The automated Role-Based Access Control (RBAC) system may begin with a comprehensive data acquisition process. This process may involve ingesting data from multiple sources to provide a holistic view of the organization's access landscape. The system may acquire entitlement graphs from various integrated platforms. These graphs may represent the current state of access permissions across different systems within the organization. The entitlement graphs may include information about Identity and Access Management (LAM) policies, Software as a Service (SaaS) groups, roles, and privilege grants.

Human Resource Information System (HRIS) attributes may also be acquired by the system. These attributes may provide authoritative information about person-to-organization relationships, including department affiliations, job titles, and employment status. The HRIS data may be crucial for contextualizing access patterns and roles within the organizational structure. The system may also collect behavioral telemetry data. This data may include information such as credential usage, resource access frequency, and last-login timestamps. Behavioral telemetry may offer insights into actual usage patterns, which may be valuable for identifying unused or excessive permissions. In addition to these data sources, the system may ingest policy constraints. These constraints may represent vendor best practices, compliance controls, and customer-defined rules. Policy constraints may serve as guidelines for evaluating and enforcing access control policies.

As shown in FIG. 1, the data acquisition phase may feed into subsequent processes, including role mining and RBAC insight evaluation. The acquired data may form the foundation for the system's analysis and decision-making capabilities. The system may employ advanced processing techniques to prepare the acquired data for role mining and analysis. In some cases, this processing may involve a machine learning pipeline, as illustrated in FIG. 6. The pipeline may begin with a feature engineering step, where raw data may be transformed into meaningful features that can be used for analysis.

Following feature engineering, the system may apply spectral clustering techniques to identify patterns and groupings within the data. This clustering may help in discovering natural role structures based on access patterns and organizational context. The processed data may then be used to train a classifier, which may be capable of categorizing new access requests or identifying anomalies in existing access patterns. The classifier may undergo fine-tuning to improve its accuracy and effectiveness. The system may incorporate a sensitivity tier assignment process for resources. This process may utilize machine learning techniques to classify resources into different sensitivity levels, ranging from very low to very high. The sensitivity tiers may be used in conjunction with other data to evaluate the risk associated with different access permissions.

The data acquisition and processing phase may lay the groundwork for the subsequent stages of the RBAC system, including the creation and management of roles at various organizational levels, as depicted in FIG. 4. By leveraging diverse data sources and advanced processing techniques, the system may be able to generate a comprehensive and nuanced understanding of the organization's access control needs.

The automated Role-Based Access Control (RBAC) system may employ a two-pronged approach to role mining and analysis: bottom-up role discovery and top-down contextualization. This approach may allow for a comprehensive understanding of access patterns and organizational structure. The bottom-up role discovery process may begin by analyzing connection patterns between identities and resources. As illustrated in FIG. 1, this process may be part of the role mining phase. The system may enumerate the complete set of connections for every identity, where connections may represent logical access paths such as groups, teams, or policies across various platforms.

The system may then cluster identities that share identical connection sets. This clustering may help identify common access patterns across the organization. Following this initial clustering, the focus may shift from identities to connections, grouping connections visited by the same identity cohort. This two-stage process may yield unique connection groups, which may form the basis for skeletal roles. The system may perform top-down contextualization. This process may integrate organizational context derived from Human Resource Information System (HRIS) data. As shown in FIG. 1, HRIS attributes may be one of the data sources ingested during the data acquisition phase. The top-down contextualization may enrich the provisional roles identified through bottom-up discovery with HRIS context. This context may include information such as department, job title, manager hierarchy, location, and tenure. By incorporating this organizational data, the system may be able to evaluate the relevance and appropriateness of roles within specific organizational units.

In some cases, the system may calculate a confidence score for each role. This score may be based on the proportion of employees in a given department or job title who possess the role. For example, if a high percentage of employees in a particular department have a certain role, that role may receive a high confidence score for that department.

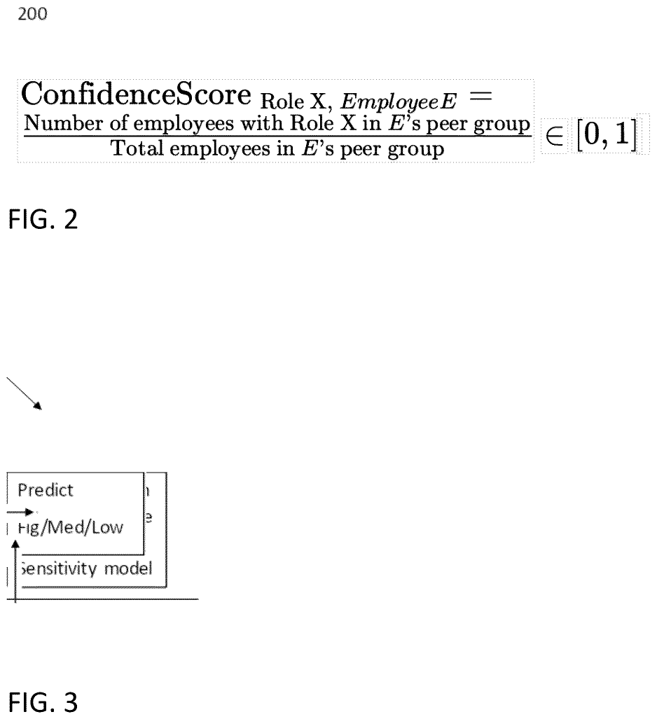

The confidence score calculation may be represented by the equation of FIG. 2, where an employee's peer group may be defined by employees who share the same department and job title.

The system may use these confidence scores to categorize roles. For instance, roles with very high confidence scores across the entire organization may be tagged as company-level roles, as depicted in FIG. 4. Roles with high confidence within a specific department may be classified as department-level roles, while those confined to a particular team may be designated as team-level roles.

The role mining and analysis process may leverage machine learning techniques, as illustrated in the pipeline shown in FIG. 6. The feature engineering step may transform raw connection and HRIS data into meaningful features. The spectral clustering stage may then identify patterns and groupings within this processed data, potentially revealing natural role structures.

By combining bottom-up discovery with top-down contextualization, the RBAC system may create a nuanced understanding of role structures within the organization. This approach may allow for the creation of roles that not only reflect actual access patterns but also align with the organizational hierarchy and business context.

The automated Role-Based Access Control (RBAC) system may perform RBAC insight evaluation to analyze and optimize role assignments across the organization. This process may involve identifying various types of access anomalies and generating recommendations for role adjustments.

In some cases, the system may identify outliers within the organization's access structure. Outliers may be identities that possess access to connections unique within the organization. The identification of outliers may help detect potential misconfigurations or security risks associated with unusual access patterns. The system may also evaluate under-entitlement scenarios. An identity may be considered under-entitled when the identity lacks access to a role that all other employees sharing the same Human Resource Information System (HRIS) attributes possess. Under-entitlement analysis may help ensure that employees have the necessary access required for their roles or functions within the organization. Conversely, the system may detect over-entitlement situations. Over-entitlement may occur when an employee has access to roles that are not assigned to anyone else in their peer group, as defined by job title, department, or organizational unit. The detection of over-entitlement may be crucial for identifying and mitigating potential security risks associated with excessive permissions.

In some cases, the system may generate role assignment recommendations for various scenarios, including new employees joining the organization, employees changing roles, or employees leaving the company. These recommendations may be based on the confidence scores derived from the role mining and analysis process, as illustrated in FIG. 1 and FIG. 6. The RBAC insight evaluation process may take into account the hierarchical role structure depicted in FIG. 4. This structure may include the company level role, the department level role, and the team level role. By considering this hierarchy, the system may generate more nuanced and context-aware insights. The system may identify and recommend a Department-Level Birthright Role. This role may be a specific type of the department level role that may be assigned to every employee within a particular department. The Department-Level Birthright Role may ensure that all members of a department have access to essential departmental resources and systems. The system may also recognize and suggest Functional Roles, which may be associated with specific functional areas or domains within the organization. Functional Roles may be considered a more specific type of the team level role, tailored to the responsibilities of particular teams or work groups. The RBAC insight evaluation may identify a Birthright Role that may be assigned to every employee in the company. This role may be considered a specific type of the company level role, providing baseline access rights that are universal across the organization. The system may also evaluate and recommend Job-Based Birthright Roles. These roles may be assigned to all employees within a department who share the same job title. Job-Based Birthright Roles may be considered a specific type of the department level role, ensuring that employees with similar job functions have consistent access rights. Additionally, the RBAC insight evaluation process may consider Location-Based Roles. These roles may be specific to employees at particular geographic locations. While not explicitly covered by the defined role types in FIG. 4, Location-Based Roles may provide an additional dimension for tailoring access rights based on physical or regional considerations.

By incorporating these various role types and evaluation criteria, the RBAC insight evaluation process may provide a comprehensive analysis of the organization's access control structure. This analysis may help identify anomalies, optimize role assignments, and maintain a secure and efficient access control environment across the organization.

The automated Role-Based Access Control (RBAC) system incorporates a findings generation and ideal state synthesis process to optimize access control policies. This process involves multiple components, including a findings engine 140, simulated remediation 150, and RBAC-drift measurement or analysis 160. The findings engine 140 may analyze the RBAC insights produced during the evaluation phase, as illustrated in FIG. 1. The engine may apply predefined rules to identify potential issues or anomalies in the access control structure. These rules may combine various signals, such as confidence scores, resource sensitivity tiers, and behavioral telemetry data. The findings engine 140 generates finding objects for each identified issue. A finding object records information such as the violating entity, the triggered rule, the associated risk level, and recommended remediation actions. This structured approach to findings generation may facilitate efficient processing and prioritization of access control issues. Following the generation of findings, the system may perform a simulated remediation process. This process may involve a hypothetical application of all recommended remediation actions identified by the findings engine. For example, the simulation may revoke excess privileges, split or merge roles, or enforce multi-factor authentication where necessary.

The simulated remediation may produce an entitlement graph representing an ideal state of the RBAC system. This ideal state graph may then be processed through the role mining and analysis phases, as shown in FIG. 1 and FIG. 6. The result of this processing may be a set of ideal roles and an optimal CRUD (Create, Read, Update, Delete) permission matrix. The system may perform RBAC-drift measurement to quantify the differences between the live RBAC state and the ideal state. This measurement may consider multiple factors, including role membership, privilege power, resource coverage, and CRUD operations.

The RBAC-drift calculation may take into account the hierarchical role structure depicted in FIG. 4, including the company level role, the department level role, and the team level role. By considering this hierarchy, the drift measurement may provide a nuanced understanding of access control discrepancies at different organizational levels.

The system may report RBAC drift metrics through dashboards and APIs, highlighting the magnitude of drift per identity, role, application, and department. These metrics may enable security teams to prioritize remediation efforts and track progress towards an optimal access control state. By continuously performing this findings generation and ideal state synthesis process, the automated RBAC system may maintain an up-to-date understanding of access control issues and provide actionable insights for improving the organization's security posture.

The automated Role-Based Access Control (RBAC) system may incorporate various remediation processes to address identified access control issues and work towards an ideal state convergence. These processes may include automated playbooks, Just-In-Time Purpose-Based Access Control (JITPBAC) sessions, and human-in-the-loop tickets. The system may utilize automated playbooks for pre-approved actions. These playbooks may execute immediate remediation steps through direct API calls to various platforms and tools. For example, an automated playbook may revoke an unused policy in a cloud platform, enforce multi-factor authentication on a group in an identity provider, or split a role that violates segregation of duties principles.

The system may implement JITPBAC sessions for privileges that should exist only for a limited time while a user performs a specific task. In some cases, a user or an automation trigger may request a short-lived “purpose” that specifies the scope, duration, and constraints of the required access. Upon approval, the system may provision the necessary entitlements, monitor usage, and automatically revoke the access when the time window or purpose expires.

For high-impact or non-deterministic changes, the system may initiate human-in-the-loop tickets. These tickets may be routed to appropriate approvers, such as managers, application owners, or security stewards. The system may provide machine-generated context along with the ticket, including risk ratings, business justifications, and least-privilege alternatives. Approvers may accept, modify, or dismiss the recommendations, and their decisions may feed back into the system as reinforcement data.

After each remediation action, whether automated or manual, the system may re-ingest fresh telemetry from all connected integrations. This process may update connection-usage statistics and re-compute role confidence scores, producing a new live identity graph. The system may then compare this updated graph against the ideal state RBAC, as determined through the findings generation and ideal state synthesis process illustrated in FIG. 1.

In some cases, the system may quantify the residual drift between the live state and the ideal state. If the drift remains above an administratively defined threshold, the system may automatically queue the next remediation cycle. This continuous comparison and adjustment process may create a closed-loop control system that perpetually aligns roles, privileges, and group memberships with the simulated ideal state.

The remediation and convergence process may take into account the hierarchical role structure depicted in FIG. 4, including the company level role, the department level role, and the team level role. By considering this hierarchy, the system may ensure that remediation actions are appropriate for each organizational level and maintain consistency across the access control structure.

The system may leverage the machine learning pipeline illustrated in FIG. 6 to enhance its remediation and convergence capabilities. The feature engineering and spectral clustering stages may help identify patterns in remediation outcomes, while the classifier training and fine-tuning steps may improve the system's ability to predict the effectiveness of different remediation actions. Through this iterative execution of the remediation and convergence loop, the live environment may asymptotically approach the ideal state RBAC. Any emergent deviations may be automatically detected and corrected before maturing into material risks, maintaining a dynamic and optimized access control environment across the organization.

The automated Role-Based Access Control (RBAC) system may incorporate a machine learning pipeline for data processing and classification. This pipeline may enhance the system's ability to analyze access patterns, categorize resources, and optimize role assignments. FIG. 6 illustrates the key components of this machine learning pipeline. The pipeline may begin with a feature engineering stage. During this stage, raw data from various sources, such as entitlement graphs, Human Resource Information System (HRIS) attributes, and behavioral telemetry, may be transformed into meaningful features. These features may capture relevant aspects of access patterns, organizational structure, and resource usage.

Following feature engineering, the pipeline may employ spectral clustering techniques. Spectral clustering may help identify natural groupings within the processed data. This clustering approach may be particularly useful for discovering latent role structures based on access patterns and organizational context.

The next stage in the pipeline may involve classifier training. The system may use the processed and clustered data to train a machine learning model capable of categorizing new access requests or identifying anomalies in existing access patterns. This classifier may play a role in automating decision-making processes within the RBAC system. The trained classifier may undergo a fine-tuning step to optimize its performance. This fine-tuning process may involve adjusting model parameters or incorporating additional data to improve classification accuracy. The machine learning pipeline may include a prediction stage where the trained and fine-tuned classifier generates outputs based on new input data. These predictions may inform various aspects of the RBAC system, such as role recommendations or anomaly detection. A feedback loop may be incorporated into the pipeline to enable continuous improvement. As shown in FIG. 6, predictions generated by the classifier may be evaluated, and the evaluation results may be fed back into the fine-tuning stage. This iterative process may allow the system to adapt to changing access patterns and organizational structures over time.

The machine learning pipeline may support various components of the RBAC system illustrated in FIG. 1, including role mining, RBAC insight evaluation, and findings generation. By leveraging machine learning techniques, the system may be able to process large volumes of data and identify complex patterns that may not be apparent through manual analysis. The machine learning pipeline may contribute to the classification of resources into sensitivity tiers. The system may employ an active-learning feedback loop to improve the accuracy of resource sensitivity classification. This process may involve presenting administrators with automatically classified resources and soliciting feedback on the accuracy of the classifications. The feedback provided by administrators may be used as additional training data for the classifier. By incorporating this human-validated data, the system may continuously refine its ability to accurately categorize resources based on sensitivity levels. This approach may help ensure that the RBAC system maintains an up-to-date understanding of resource sensitivity without requiring constant manual oversight.

The machine learning pipeline may also support the hierarchical role structure depicted in FIG. 4, which includes the company level role, the department level role, and the team level role. The classifier may learn to recognize patterns associated with these different role levels, enabling more nuanced and context-aware access control decisions. By integrating this machine learning pipeline into the RBAC system, organizations may be able to achieve more dynamic, accurate, and efficient access control management. The pipeline's ability to process complex data, identify patterns, and continuously improve may help the system adapt to evolving organizational structures and security requirements.

The automated Role-Based Access Control (RBAC) system may incorporate an organizational role hierarchy to structure access rights across different levels of the organization. This hierarchy may provide a framework for distributing and inheriting roles from the company level down to individual users. In some cases, the organizational role hierarchy may include multiple levels, as illustrated in FIG. 4. The hierarchy may begin with the company level role, which may represent access rights that are applicable across the entire organization. The company level role may serve as a foundation for more specific roles at lower levels of the hierarchy.

Below the company level role, the hierarchy may include the department level role. The department level role may inherit access rights from the company level role and may add department-specific permissions. This structure may allow for tailored access control within different departments while maintaining consistency with organization-wide policies.

At a more granular level, the hierarchy may incorporate the team level role. The team level role may inherit permissions from both the company level role and the relevant department level role. Additionally, the team level role may include access rights specific to the functions and responsibilities of particular teams or work groups within departments. Individual users may receive a combination of roles inherited from higher levels of the organizational hierarchy. For example, a user may be assigned the company level role, a relevant department level role, and one or more team level roles based on their position and responsibilities within the organization.

The organizational role hierarchy may interact with other components of the RBAC system, as depicted in FIG. 1. For instance, the role mining process may take into account the hierarchical structure when analyzing access patterns and generating role recommendations. The RBAC insight evaluation phase may consider the inheritance of roles through the organizational structure when identifying potential access anomalies or optimization opportunities.

The machine learning pipeline illustrated in FIG. 6 may also incorporate the organizational role hierarchy into its analysis. The feature engineering stage may extract relevant information about the hierarchical relationships between roles, while the spectral clustering and classifier training stages may learn to recognize patterns associated with different levels of the hierarchy.

By leveraging this hierarchical approach to role organization, the RBAC system may provide a structured and scalable method for managing access rights across complex organizational structures. The hierarchy may facilitate consistent application of access policies while allowing for necessary variations at different organizational levels. The automated Role-Based Access Control (RBAC) system may be implemented and integrated into existing organizational structures through a modular and scalable approach. This approach may allow organizations of various sizes and complexities to adopt the system while minimizing disruption to existing workflows. The implementation process may begin with the integration of data sources. The system may connect to existing Human Resource Information System (HRIS) platforms, identity providers, and cloud services to ingest the necessary data for role mining and analysis. This integration may leverage standard APIs and data exchange protocols to ensure compatibility with a wide range of enterprise systems.

The system may adapt to different organizational needs by allowing customization of the role hierarchy depicted in FIG. 4. While the figure illustrates a three-tier structure with the company level role, the department level role, and the team level role, organizations may modify this hierarchy to reflect their specific structures. For example, a large multinational corporation may add a regional level role between the company and department levels to account for geographical divisions. The RBAC system may provide a configuration interface for administrators to define custom attributes and rules. This interface may allow organizations to incorporate industry-specific or company-specific factors into the role mining and analysis processes shown in FIG. 1. For instance, a healthcare organization may define attributes related to medical specialties or patient care roles, which the system may then consider when generating RBAC insights.

The scalability of the system may be achieved through a distributed architecture. In some cases, the data processing and machine learning components illustrated in FIG. 6 may be deployed across multiple servers or cloud instances. This distributed approach may allow the system to handle large volumes of data and complex organizational structures without compromising performance.

For organizations with existing role management systems, the RBAC system may offer integration capabilities. In some cases, the system may operate in a hybrid mode, where the existing roles are imported and analyzed alongside the newly discovered roles. This integration may facilitate a gradual transition to the new RBAC model while preserving valuable institutional knowledge embedded in existing role definitions.

The system may adapt to organizational growth and changes through continuous monitoring and adjustment. As new departments or teams are added, the role mining process may automatically identify new patterns and suggest appropriate roles. Similarly, when organizational restructuring occurs, the system may reevaluate existing roles and recommend adjustments to maintain alignment with the new structure.

In some cases, the RBAC system may offer multi-tenancy support for managed service providers or large enterprises with multiple subsidiaries. This feature may allow a single instance of the system to serve multiple organizations while maintaining strict data segregation and role isolation between tenants.

The implementation may include a phased rollout strategy. Organizations may begin by applying the RBAC system to a subset of their infrastructure or specific departments. This approach may allow for validation of the system's effectiveness and fine-tuning of configurations before a full-scale deployment.

To facilitate adoption and user acceptance, the system may provide intuitive visualization tools for role structures and access patterns. These visualizations may help administrators and managers understand the implications of role changes and identify potential areas for optimization.

In some cases, the RBAC system may offer integration with identity federation protocols such as SAML or OpenID Connect. This integration may allow the system to extend its role management capabilities across multiple applications and services, providing a unified access control framework for both on-premises and cloud-based resources.

The system may also provide extensibility through a plugin architecture. This architecture may allow organizations or third-party developers to create custom modules that extend the system's capabilities. For example, a plugin may be developed to integrate with a specific compliance framework, automating the generation of audit reports based on the RBAC data.

By offering these implementation and integration options, the automated RBAC system may adapt to a wide range of organizational needs and technical environments. The system's flexibility and scalability may enable organizations to implement robust access control measures while accommodating their unique structures and requirements.

The automated Role-Based Access Control (RBAC) system may provide organizations with a comprehensive solution for managing access rights across diverse computing environments. By leveraging advanced data analysis techniques and machine learning algorithms, the system may offer several advantages over traditional access management approaches.

In some cases, the system may maintain least-privilege access by continuously analyzing access patterns and organizational structures. The role mining process, as illustrated in FIG. 1, may identify optimal role configurations that align with actual business needs. This approach may help reduce the risk of over-entitlement and minimize the potential impact of security breaches.

The system may incorporate a hierarchical role structure, as depicted in FIG. 4, which may include the company level role, the department level role, and the team level role. This structure may allow for granular access control while maintaining consistency across the organization. By automatically adjusting roles based on changes in the organizational structure, the system may help ensure that access rights remain appropriate as employees move between departments or take on new responsibilities.

In some cases, the automated RBAC system may significantly reduce administrative overhead associated with access management. The machine learning pipeline shown in FIG. 6 may enable the system to process large volumes of data and identify complex patterns without constant manual intervention. This automation may free up IT and security personnel to focus on higher-value tasks, potentially improving overall operational efficiency.

The system may enhance an organization's security posture through continuous monitoring and adjustment of access rights. By regularly comparing the current state to a dynamically computed ideal state, as described in the role mining and analysis process in FIG. 1, the system may quickly identify and address potential security risks. This proactive approach may help organizations stay ahead of evolving threats and maintain compliance with regulatory requirements.

In some cases, the automated RBAC system may provide improved visibility into access patterns across the organization. The system may generate detailed reports and visualizations that help security teams and administrators understand “who can do what, where, and why” across all environments. This enhanced visibility may support more informed decision-making and facilitate more effective risk management.

The system may adapt to changing organizational needs through its flexible and scalable architecture. As new applications or resources are added to the environment, the system may automatically incorporate them into the role mining and analysis processes. This adaptability may help ensure that the RBAC configuration remains effective and efficient as the organization grows or evolves.

In some cases, the automated RBAC system may support compliance efforts by providing detailed audit trails and evidence of control effectiveness. The system may generate reports that demonstrate the implementation of least-privilege principles and the regular review of access rights, which may be valuable for meeting regulatory requirements.

The system may offer a data-driven approach to role management, leveraging statistical analysis and machine learning to generate high-confidence roles. This approach may help reduce the subjectivity and potential errors associated with manual role definition and assignment processes.

In some cases, the automated RBAC system may improve the overall user experience by streamlining access provisioning and reducing the likelihood of access-related disruptions. By maintaining accurate and up-to-date role assignments, the system may help ensure that employees have the access they need to perform their jobs effectively, while minimizing unnecessary or outdated permissions.

FIG. 1 shows a flowchart of a method of control according to the present invention. The flowchart shows the following aspects.
1. Data Acquisition—The system ingests four complementary data streams:
a. Entitlement Graphs from each integrated platform (IAM policies, SaaS groups, roles, privilege grants)
b. HRIS Attributes providing authoritative person-to-organization relationships (department, job title, employment status)
c. Behavioral Telemetry such as credential usage, resource access frequency, and last-login timestamps
d. Policy Constraints representing vendor best practices, compliance controls, and customer-defined rules
2. Bottom-Up Role Discovery—For every identity, the engine enumerates its complete set of connections (logical access paths such as Okta groups, GitHub teams, AWS IAM policies). Identities that share an identical connection set are provisionally clustered; the focus then shifts from identities to connections, grouping connections visited by the same identity cohort. This two-stage matrix factorization yields unique connection groups—the skeletal roles.
3. Top-Down Contextualization—Each provisional role is enriched with HRIS context. The proportion of employees in a given department/job title possessing the role becomes its confidence score. Roles with 100% coverage in the company are tagged Birthright; roles universal to a department are Department Birthright; roles confined to a manager's team become Functional; and so forth. Low-confidence roles (<25%) trigger scrutiny for over-entitlement.

### Algorithm:

a. Create Identity-Connection Groups: Start by identifying the set of connections each identity has, mapping the relationships between users or entities and resources. This forms the foundation for understanding access patterns across the organization.
b. Group Connections Shared by the Same Set of Identities: Grouping connections that are accessed by the same set of identities. This reduces redundancy, prevents role sprawl, and simplifies onboarding and role modifications. The focus is on managing connections centrally, rather than repeatedly assigning them to individual roles.
c. Integrate HRIS Information to Assess Role Significance. After creating roles using the bottom-up grouping approach, we integrate HRIS data, which includes information on employees' departments, job titles, tenure, manager and other organizational attributes. By combining this HRIS data with the generated roles, the system can determine role relevance: Assess whether employees in specific departments or with certain attributes should or should not have access to a particular role, based on their organizational context. Achieve Least Privilege Access: This helps in aligning role assignments with the principle of least privilege, ensuring that employees have only the access necessary for their job functions, thereby enhancing security. Identify Anomalies: Detect any discrepancies, such as employees having access to roles that are not relevant to their job descriptions or departments, highlighting potential security risks or misconfigurations.
d. RBAC Insights Evaluation and Recommendations. The engine evaluates every identity-role pairing and determines the following RBAC insights and recommendations:
   Outlier—Identities are flagged as outliers if they possess access to connections unique within the organization. This can indicate misconfigurations or potential security risks.
   Under-Entitlement—An identity is considered under-entitled when it lacks access to a role that all other employees sharing the same HRIS attributes (e.g., department, job title, or location) possess. This condition suggests that the identity may be missing essential access required for their role or function.
   Below-Threshold Role—Using confidence scores based on HRIS data, this feature identifies roles that are rare within a particular job title or department, highlighting specialized or restricted roles. A low confidence score (default 25%) indicates unusual or rare access assignments.
   Over-Entitlement—Using the algorithm, we can identify an over-entitled employee or identity. Over-entitlement occurs when an employee has access to role(s) that are not assigned to anyone else in their peer group, which is defined by having the same job title, department, or organizational unit. This suggests that the employee holds permissions beyond what is typically required for their role or department, potentially posing a security risk or indicating an unnecessary privilege that should be reviewed. It is detected either when multiple roles assigned to one user all carry low confidence, or when role-overlap with peers is <25%.
   Role Assignment Recommendations for Joiners/Movers/Leavers—Confidence-scored roles drive automated provisioning, adjustment, or revocation workflows for joiners, movers and leavers.
   Access Review Recommendations—Incorporating confidence scores derived from HRIS data into the access review process significantly enhances decision-making accuracy and efficiency. Confidence scores can be calculated by simulating approval of that review and performing RBAC role mining. By leveraging these scores, organizations can streamline access approvals and denials based on a clear, data-driven methodology. For instance, a confidence score of 100% suggests that access should be automatically approved, reflecting a high degree of certainty about the appropriateness of the role assignment. Conversely, a score below 25% indicates that access should be denied, as it suggests a low confidence in the role's relevance. Scores falling between these thresholds are flagged for deeper review, ensuring that more complex cases receive thorough examination. This approach not only optimizes the access review process but also ensures alignment with organizational policies and enhances overall security.
   Role-Merge Recommendations—When significant overlap is detected between roles—particularly where multiple employees share the same access patterns—roles are recommended for merging. Agglomerative clustering merges roles whose employee sets overlap and whose combined SoD checks pass. This reduces role sprawl and simplifies access management by consolidating redundant roles.
e. Findings Generation and Ideal State Synthesis:
   Findings Engine. RBAC Insights produced in Step d and other insights derived via application extractors (e.g. MFA Missing, Unused Credentials, etc.) and User-defined insight definitions (E.g. SoDs, Privileged Connections) flows into a rule engine. Administrators—or pre-packaged security frameworks—define finding rules that combine these labels with additional signals such as resource-sensitivity tiers, behavioral telemetry (last-use timestamps, access frequency), and compliance mappings. A rule is essentially a constraint “No identity with a confidence score below 25% may hold delete privileges on a High-sensitivity resource.” Whenever an identity or role violates any active constraint, the engine emits a Finding object that records the violator, the triggering rule, inherent risk, and a recommended remediation.
   Simulated Remediation—To calculate the Ideal State RBAC, the system performs a dry-run in which all open findings are hypothetically remediated (e.g., excess privileges revoked, roles split or merged, MFA enforced). The entitlement graph produced by this simulation is then re-processed through steps 2-4—bottom-up discovery, top-down contextualization, and constraint evaluation—to synthesize a fresh set of ideal roles and an “ideal” CRUD permission matrix.
   RBAC-Drift Measurement. Divergences between live roles and ideal roles are quantified along multiple axes (membership, privilege power, resource coverage, CRUD operations) and reported as RBAC drift. Dashboards and APIs highlight the drift magnitude per identity, role, application, and department, enabling prioritization of remediation work.
f. Remediation, Ideal-State Convergence, and Feedback Loop. Once findings are generated, the platform initiates remediation workflows through two complementary channels: Automated playbooks.

Pre-approved actions—such as revoking an unused AWS policy, enforcing MFA on an Okta group, or splitting a role that violates SoD—are executed immediately via direct API calls to identity providers (Okta, Azure AD), cloud platforms (AWS IAM, GCP IAM), SaaS admin endpoints (GitHub, Jira), or ITSM tools (ServiceNow, Jira SM). Each action is logged with a cryptographic hash to provide tamper-evident audit proof.

JITPBAC sessions—For privileges that should exist only while a user is performing a narrowly defined task (e.g., emergency database patching, vendor troubleshooting), the engine initiates a

Just-In-Time Purpose-Based Access Control grant. The user (or an automation trigger) requests a short-lived “purpose” that specifies scope, duration, and constraints; upon approval, the system provisions the necessary entitlements, monitors usage, and automatically revokes them when the time window or purpose expires-eliminating standing access without delaying urgent work.

Human-in-the-loop tickets. High-impact or non-deterministic changes (e.g., removing delete privileges from a production database role) are routed to the appropriate approver-manager, application owner, or security steward-along with machine-generated context: risk rating, business justification, and least-privilege alternative. Approvers can accept, modify, or dismiss the recommendation; their decision feeds back into the model as reinforcement data. After each remediation (automatic or manual), the system re-ingests fresh telemetry from all connected integrations, updates connection-usage statistics, and re-computes role confidence, thereby producing a new live identity graph. This graph is instantly compared against the Ideal State RBAC (Section 5.2) to quantify residual drift. If drift remains above an administratively defined threshold—say, >5% of identities with low-confidence roles—the engine automatically queues the next remediation cycle.

The result is a closed-loop control system with the following properties:
a. Continuous Alignment. Roles, privileges, and group memberships are perpetually pulled toward the simulated ideal, preventing the quiet accumulation of excess access.
b. Measurable Progress. Dashboards display real-time drift metrics (role overlap, privilege power delta, inactive-high-risk count) so risk owners can visualize convergence toward least privilege.
c. Audit-Ready Evidence. Every remediation—including the before/after privilege set and the drift delta it closed—is exported as a signed record, satisfying auditors that least-privilege posture is both enforced and provable.
   Through iterative execution of this orchestration loop, the live environment asymptotically approaches the Ideal State RBAC, and any emergent deviation is automatically detected and corrected before it can mature into material risk.

FIG. 2 shows a confidence score equation 200 according to the present invention. FIG. 3 shows a flowchart 300 for a method of prediction. FIG. 4 shows an organization chart 400 according to the present invention. Role Relevance & Confidence Score—Role relevance is a measure of how significant or common a role is for a specific department x job-title cohort within an organization. It helps determine whether a role is essential (such as “birthright” roles) or whether it requires further scrutiny due to its specialized nature or potential security implications. This relevance can inform decisions about access management, security, and organizational efficiency. The confidence score is used to quantify role relevance. It is calculated by taking the number of employees with the same job title and department who have access to a specific role and dividing it by the total number of people with that same job title and department. The score ranges between 0 and 1. It reflects how commonly a role is assigned within a peer group and can be used to identify roles that may need closer monitoring, adjustments, or even removal.

A Confidence Score equation is shown in FIG. 2 where employee E's peer group is defined by employees who share the same department and job title as Employee E High scores (≥0.75) identify birthright or broadly required roles, whereas low scores (≤0.25) spotlight niche or anomalous assignments that merit scrutiny or removal. Thresholds are tunable per tenant and referenced by finding-rule templates supplied for common standards (PCI-DSS, ISO 27001, NIST CSF) or by user-defined finding rules. Confidence is recomputed after every sync so role relevance adjusts as the workforce changes. Resource Sensitivity—The value of any privilege hinges on what it can touch. To quantify that dimension, the invention furnishes a machine-learned Resource Sensitivity Model that classifies every addressable object-whether a Salesforce record, an S3 bucket, a Kubernetes secret, or a line in a firewall rule-onto a five-point ordinal scale (Very Low→Very High). The model is fully data-driven; administrators need not pre-label assets, yet they may fine-tune outcomes through active-learning feedback.

Phase 1—Feature Extraction
a. Organizational Location (OL). Using metadata keys (e.g., AWS tags, GitHub repo paths, SaaS “owner” fields), each resource is placed on a containment path team→department→enterprise. OL encodes business-criticality implied by the owning unit.
b. Privilege Envelope (PE). All CRUD operations granted on the resource are projected into a four-bit vector, then folded into a scalar privilege-power score via the mapping Delete=3, Create/Update=2, Read=1. A database table with Update+Read therefore scores 3; a log bucket that is read-only scores 1.3.
c. Accessibility Graph (AG). A bipartite graph connects identities to resources through permission edges. For each resource we compute betweenness centrality, where σ denotes shortest paths. BC yields three nested visibility measures: intra-team, intra-department, and enterprise-wide.

Phase 2—Spectral Clustering & Tier Mapping—The feature tensor F=[OL, PE, BC_team, BC_dept, BC_co] is fed to a normalized-Laplacian spectral clustering routine. The eigen-gap automatically selects k clusters; empirical testing shows k∈{3, 5}. Centroids are then aligned to semantic tiers by ranking their visibility and privilege-power medians. The mapping rule table is preserved verbatim as shown in the sensitivity tier chart 700 of FIG. 7.

Phase 3—Sanity Checks & Active Learning—Post-clustering heuristics correct obvious divergences (e.g., a Very High resource with >70% company visibility is down-graded) and flag gray-zone items for analyst review. The platform then samples auto-labeled resources and solicits customer confirmation; their edits create a labelled validation set that feeds an incremental re-training pass, typically improving F1-score.

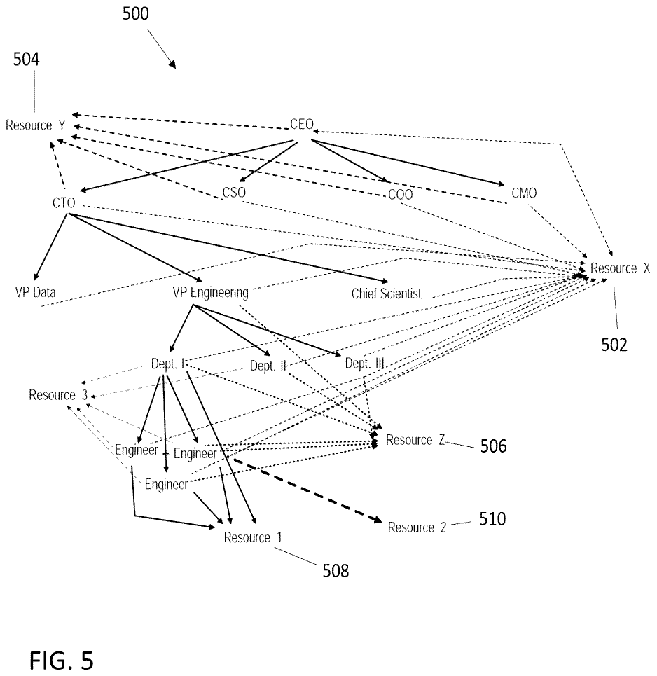

FIG. 6 shows a flowchart 600 showing the process of building the model of FIG. 5.

Integration with Finding Rules and JITPBAC. The finalized sensitivity tier is persisted as an attribute on each resource node within the global entitlement graph. Finding-rule templates and SoD matrices reference the sensitivity of resources directly, enabling expressions like “deny Delete on High+ Sensitivity resources to contractors” Or “require multi-party approval for JITPBAC sessions that elevate into Very High Sensitivity Resources”. Because sensitivity is recomputed whenever resource metadata or accessibility changes, privileges that drift toward higher-risk resources are automatically surfaced for remediation.

Permissive Power (CRUD)—Permissions are normalized to Create, Read, Update, Delete and then scored:
a. Delete→highest privilege power
b. Create/Update→high privilege power
c. Read→low privilege power
   Finding rules determine risk by reasoning over the Cartesian product of permissive power of a connection and resource sensitivity; e.g., Delete×Very-High is automatically high-risk.

### Role Types:

a. Birthright Role: The algorithm identifies a role as “Birthright” if it detects that every employee within the company has access to it. These roles can be automatically assigned to all users upon joining the organization. Department-Level Birthright Role: A role is labeled as a “Department-Level Birthright” when the algorithm identifies that every employee within a specific department has access to it. These roles are critical for ensuring that all members of a department have the necessary permissions to perform their daily tasks, such as access to department-specific software or shared resources.
b. Job-Based Birthright Role: The algorithm categorizes a role as “Job-Based” when it is assigned to all employees within a department who share the same job title. This type of role is tailored to the specific responsibilities and needs of a particular job function, ensuring that employees have access to the tools and information necessary for their specific role, such as a project manager or data analyst within a department.
c. Functional Role: These roles are associated with specific functional areas or domains within the organization. The algorithm assigns a “Functional Role” label when all employees under a particular manager or within a specific team share the same access.
d. Location-Based Role: A “Location-Based Role” is assigned when the algorithm detects that a role is specific to employees at a particular geographic location.

Hypothesis: If access rights are clustered by shared connection sets and validated against organizational context plus policy constraints, then the resulting RBAC configuration will (a) mirror actual business structure, (b) minimize redundant permissions, and (c) materially reduce security risk without degrading user productivity. The hypothesis further posits that continuous drift detection and on-demand orchestration can keep the live environment within an acceptable tolerance of the ideal state even as the workforce and application portfolio evolve.

FIG. 4 shows an organization chart according to the present invention.

Analysis: The hypothesis asserts that grouping by connections, rather than identities, is a superior approach for achieving efficiency and scalability in access management.

The bottom-up grouping of connections feeds directly into a top-down validation loop powered by HRIS attributes (department, job title, manager hierarchy, location, tenure) and by continuously refreshed behavioral telemetry (last-login timestamps, resource-touch frequencies, privilege-use counts). This fusion produces a multi-dimensional confidence score for every role: a statistical measure of how strongly the role aligns with peer-group norms and with declared security constraints. Roles whose confidence falls beneath configurable thresholds are flagged as potential over- or under-entitlements, driving automated finding-rules that surface concrete, actionable findings.

Those findings in turn fuel the simulation engine that generates the Ideal State RBAC. Each finding carries a deterministic remediation payload—revocation, split, merge, Just-In-Time Purpose-Based Access Control (JITPBAC) grant, or policy correction—that is applied in silico. The resulting “clean” entitlement graph is re-mined using the same connection-centric algorithm, yielding a canonical set of high-confidence, least-privilege roles. The platform then computes RBAC Drift as a delta between live roles (post-sync) and the ideal set, quantifying both structural divergence (extra or missing connections) and risk divergence (residual violations of SoD, sensitivity constraints, or regulatory templates).

By adopting this approach, the organization can create a more streamlined and manageable access control system that effectively reduces administrative complexity, aligns with security policies, and is scalable to accommodate future growth. The hypothesis provides a clear framework for evaluating the method's effectiveness, focusing on key metrics such as efficiency, redundancy reduction, and prevention of role sprawl.

Conclusion—The invention delivers a holistic, adaptive RBAC framework that transforms raw entitlement chaos into coherent, least-privilege roles. By fusing bottom-up data mining with top-down business intelligence, it transcends the limitations of static role catalogs and manual reviews. The system's confidence-scored roles, drift analytics, and automated remediation workflows empower organizations to:
a. Shrink attack surfaces by revoking unused or excessive privileges.
b. Accelerate onboarding and off-boarding with deterministic, context-aware role assignments.
c. Pass audits and meet regulatory obligations with machine-generated evidence of control effectiveness.
d. Maintain a living alignment between security policy and operational reality—with near-zero human toil.

In a threat landscape where accesses and requirements change by the minute, this self-healing RBAC methodology offers a sustainable path to least-privilege access governance at enterprise scale.

Another aspect of the invention is a system for recommendation of RBAC (Role based access control) postures for identities across applications, assets and infrastructure in an organization. Using a unified virtualized RBAC and artificial intelligence, recommend role/group/policy/permissions postures for identities across applications, assets and infrastructure in an organization.

Another aspect of the invention is a system for modeling risks in identity perimeters and RBAC (role-based access control) based on expressed attributes, user behavior analytics and data classifications. Based on expressed attributes, peer group analysis, UEBA (user behavior analytics) and data classification across mapped (team members mapped to identities) as well as unmapped identities (service accounts, bot accounts), carry out risk ranking of various identities, applications/infrastructure/assets, coarse grain entitlements (roles, policies, groups, teams, permission sets, et al generally covered as RBAC—role based access control) and fine grain entitlements (underlying permissions, privileges) using Artificial Intelligence.

Another aspect of the invention is a system for unified virtualized risk mapped RBAC (Role based access control) model across applications, infrastructure and assets landscape in an organization. The unified, risk-mapped role-based access control (RBAC) model risks such as segregation of duties, terminations, general outliers, etc. (not limited to) across an organization's software, cloud landscapes by leveraging data science to interrogate various environments for inherent and residual entitlement risks. In addition, the model also virtualizes the role-based access control across the various environments by inferring and modeling RBAC based on data and artificial intelligence.

Another aspect of the invention is a method for determining and extracting validity of controlled access granted to an identity through algorithmic processing of related employment data, relevant policies, and peer information. The method allows external systems to request real time access control decisions based on collected employee data, organizational policies, peer information, and previous decisions either from manual or accepted machine-made decisions.

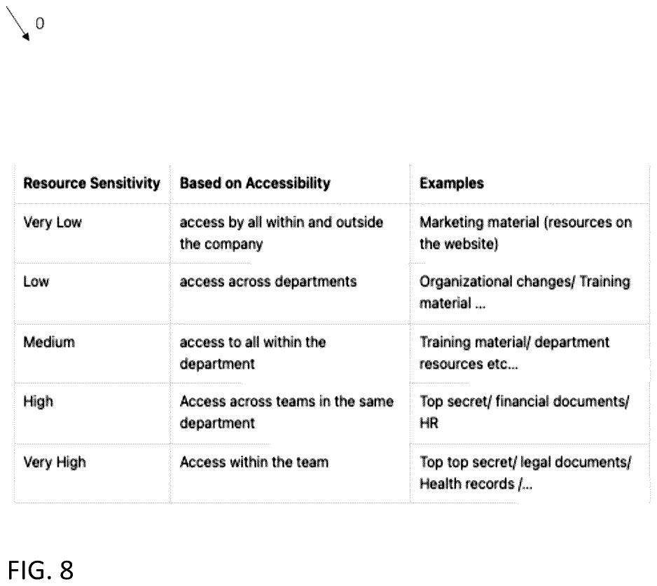

Another aspect of the invention is a machine learning and complex network approach to predict resource sensitivity based on the resource accessibility in a company. In one example, a base resource sensitivity model 500 is shown in FIG. 5. To build the base resource sensitivity model, the system considers where each resource is in the organization. The system also considers how accessible the resource is and what kind of actions user can perform on the resource. FIG. 6 illustrates a flowchart showing the process of building the base resource sensitivity model of FIG. 5. FIG. 8 shows an assumption chart indicating assumptions made for each of the features.

Sensitivity Analysis is used in modeling to analyze how the different values of a set of independent variables affect a specific dependent variable under certain specific conditions.

The base resource sensitivity model uses data including organizational structure and permissions on a resource. The base resource sensitivity model also uses resource accessibility to identify accessibility of a resource in a team, department & the company using betweenness centrality. Betweenness centrality provides an indication on how visible a resource is to the member of team/department/organization the resource appears to be part of. The base resource sensitivity model uses the data to extract features which are then passed to a spectral clustering algorithm to generate labels. Spectral clustering labels are converted using the assumptions 800 in FIG. 8. into Low/Medium/High or Very Low/Low/Medium/High/Very High (depending on number of clusters detected by spectral clustering) Additional checks are performed on the labels, making adjustments to the labels if required and using the labels to train the classifier. Once the base resource sensitivity classifier is ready, customers are presented with a plurality of labelled samples which they can either accept or make changes to. Based on customers feedback, the model is retrained to achieve higher accuracy as compare to base model.

In some embodiments for the automated role-based access control RBAC management system, instructions or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, SSDs, flash drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for discovering and grouping permissions in an organization, the method comprising:
analyzing the intersection of identities and the resources they actively consume, thereby eliminating redundant role definitions and connection duplication;
integrating human resource information system data including department, job title, manager hierarchy, location, and tenure to calculate a statistical confidence score that quantifies role relevance within a peer group;
enforcing the principle of least privilege by applying tunable policy constraints; and
generating role-merge and role-split recommendations based on overlap analysis and segregation-of-duties checks, ensuring that each synthesized role is internally consistent and non-redundant;
wherein an ideal role-resource graph is produced by simulating the remediation of every open finding; the system then measures and reports RBAC drift—the delta between the ideal and live graphs in real time, giving security teams a quantitative target for continuous improvement.

2. The method according to claim 1 wherein the method exposes a risk-weighted findings engine for aggregating insight labels into holistic findings per identity, application, or business role, including impact explanations and remediation workflows.

3. The method according to claim 1 wherein a machine-learning pipeline ingests organizational location, privilege envelope, and accessibility-graph features and assigns every resource a Very-Low to Very-High sensitivity tier, enabling precise risk evaluation of resources that are independent of manual tagging.

4. The method according to claim 1 wherein the model incorporates an active-learning feedback loop whereby administrator edits to resource-sensitivity labels are stored as training data and used to retrain the classifier, yielding progressively higher accuracy without full retraining cycles.

5. The method according to claim 1 wherein tenant-configurable confidence thresholds allow each organization to fine-tune sensitivity and role confidence thresholds; deviations from these thresholds instantly spawn findings whose risk weights scale with the size of the deviation, ensuring that the most anomalous privileges rise to the top of remediation queues.

6. The method according to claim 1 wherein the method operates in a zero-touch mode, requiring customers only to connect integrations; the system harvests entitlements, synthesizes RBAC, and presents prioritized recommendations without manual rule-writing unless preferred by the organization.

7. A system for automated role-based access control (RBAC) management, comprising:
a data acquisition module configured to ingest entitlement data from multiple computing environments;
a role mining module configured to perform bottom-up role discovery and top-down contextualization;
an RBAC insight module configured to generate access control insights;
a findings engine configured to create findings based on the RBAC insights;
an ideal state synthesis module configured to generate an ideal RBAC state; and
a remediation module configured to initiate actions to converge a live RBAC state towards the ideal RBAC state.

8. The system of claim 7, wherein the data acquisition module is configured to ingest data from identity graphs, Human Resource Information System (HRIS) attributes, and behavioral telemetry.

9. The system of claim 8, wherein the role mining module is configured to:
enumerate a complete set of connections for every identity; and
cluster identities that share identical connection sets.

10. The system of claim 9, wherein the role mining module is further configured to:
enrich provisional roles identified through bottom-up discovery with HRIS context; and
calculate a confidence score for each role based on the proportion of employees in a given department or job title who possess the role.

11. The system of claim 10, wherein the RBAC insight module is configured to identify outliers, under-entitlement scenarios, and over-entitlement situations based on the confidence scores and organizational data.

12. The system of claim 11, wherein the findings engine is configured to apply predefined rules to identify potential issues or anomalies in the access control structure.

13. The system of claim 12, wherein the remediation module is configured to:
execute automated playbooks for pre-approved actions;
implement Just-In-Time Purpose-Based Access Control (JITPBAC) sessions for time-limited privileges; and
initiate human-in-the-loop tickets for high-impact or non-deterministic changes.

14. A method for creating a base resource sensitivity model, the method comprising:
using data to extract features;
passing the features to a spectral clustering algorithm for generating labels;
converting spectral clustering labels to one of a low value, a medium value or a high value;
performing additional checks on the labels;
adjusting to the labels if required; and
using the labels to train the classifier.

15. The system of claim 14 wherein once the base resource sensitivity classifier is ready, customers are presented with a plurality of labelled samples for acceptance or for making changes.

16. The system of claim 14 wherein based on customers feedback, the model is retrained to achieve higher accuracy as compare to base model.

17. The system of claim 14 wherein the data includes organizational structure, permissions on a resource, and resource accessibility.

18. The system of claim 14 wherein the system identifies accessibility of a resource in a team, department & the company using betweenness centrality.

19. The system of claim 18 wherein the betweenness centrality provides an indication on how visible a resource is to the member of team/department/organization the resource appears to be part thereof.
